(19) United States
(12) Patent Application Publication
(10) Pub. No.: US 2003/0104789 A1
(43) Pub. Date: Jun. 5, 2003

(54) User interface for a handheld wireless communication device

(76) Inventors: Tonya Torri, Grayslake, IL (US); Ross Ripley, Gurnee, IL (US)

Correspondence Address: MOTOROLA INC, 600 NORTH US HIGHWAY 45, LIBERTYVILLE, IL, 60048-5343, US

(21) Appl. No.: 10/006,098

(22) Filed: Dec. 4, 2001

(51) Int. Cl. H04B 1/38

(52) U.S. Cl. 455/90; 455/575

(57) ABSTRACT

A user interface (302) disposed upon a handheld wireless communication. The handheld wireless communication device comprises a first housing portion (120) and a second housing portion (220). The user interface is place on a first surface (403) of the first housing portion. The first housing portion and the second housing portion rotate planarly in respect to one another such that in a closed position the first housing portion is planarly adjacent to the second housing portion. The user interface is disposed on the first surface such that the user interface is enclosed between the first housing portion and the second housing portion when the device is in a closed position. Furthermore, the user interface is accessible to he user and located proximal to the user's finger while in use in the open position. This allows for easy activation of the user interface during use.

### BACKGROUND OF THE INVENTION

The present invention relates generally to a user interface, and more particularly to the user interface of a handheld wireless communication device.

Portable electronic devices often fold together or fold upon themselves, in one fashion or another to reduce the size of the device. Some devices fold together in order to reduce the storage space, while others fold together to improve functionality. These devices often employ a user interface to control functions of the device. Because of the miniature nature of these devices in conjunction with the increasing functionality however, some or additional portions of the user interface are disposed upon the outer surface of the device, and exposed even while the device is in a closed position. An outwardly exposed user interface creates a device that does not have a smooth or continuous outer surface leaving the device un-esthetically pleasing to the user.

Additionally, when the device is in the closed position, in many cases when it is being transported, it is exposed to the elements such as dirt and grime which infiltrate the user interface. For example, a radiotelephone is often carried in a purse or pocket, which collect dirt, debris and small objects which may then enter the user interface through openings in the housing. As dirt and grime build up inside the user interface, the buttons or mechanical inner workings of the user interface begin to fail. This is highly undesired by the user.

In some instances, the buttons may be in an active state while the device is in a closed position. This generally allows the user to control certain aspects of the device that are advantageous while the device is in a closed position. For example, in a radiotelephone, the user may want to control the alert mode which does not necessitate the opening of the device to do so. However, this also presents a problem wherein the buttons may be inadvertently pushed or activated when it is not desired.

Accordingly, a system is needed to improve the esthetics and protect the user interface. Providing a means to allow the device functionality to increase yet maintain esthetically pleasing surface to the user and protect the interface form inadvertent subjection to the environment is needed

### BRIEF DESCRIPTION OF THE DRAWINGS

FIG. 1 is a perspective view of a radiotelephone in a closed position.

FIG. 2 is a perspective view of the radiotelephone of FIG. 1 in an opened position as well as two alternative positions.

FIG. 3 is a perspective view of the backside of the radiotelephone of FIG. 2 in an open position.

FIG. 4 is a side view of the radiotelephone as it is held by the user.

### DETAILED DESCRIPTION OF INVENTION

The present invention is a handheld wireless communication device comprised of two housing portions. The first housing portion comprises an inner surface and an outer surface and the second housing portion comprises an inner surface and an outer surface. The second housing portion is rotatably coupled within the same plane to said first housing portion, such that in a first or closed position, the inner surface of the first housing portion is planarly adjacent to the inner surface of the second housing portion. In a second or open position, the inner surface of the first housing portion is exposed and planarly opposed from said inner portion of said second housing portion.

The handheld wireless communication device further comprises a user interface disposed upon the inner surface of said second housing portion. When the device is in the open position, the user interface is exposed and accessible to the user and concealed when the device is in the closed position. The user interface is located on the inner surface of the second housing portion such that when the device is in use, the user's index finger naturally rests near or on the user interface.

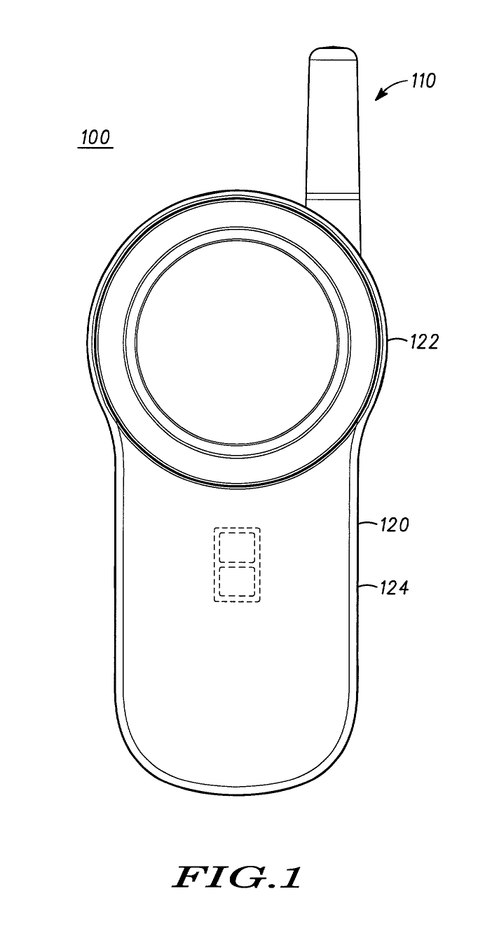

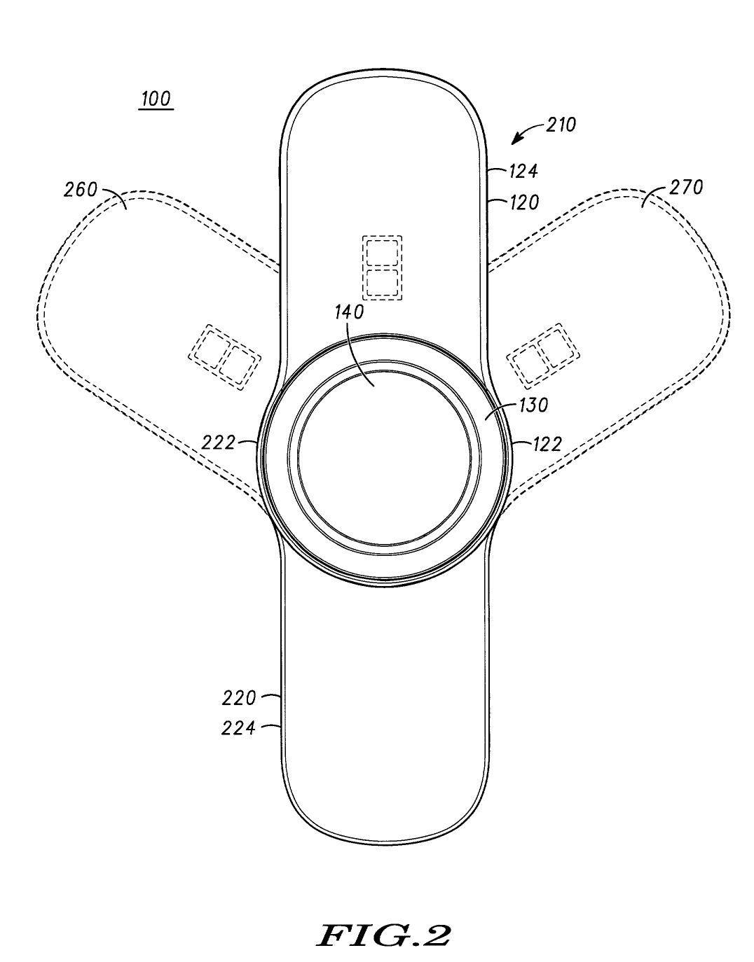

FIG. 1 shows the handheld wireless communication or radiotelephone 100, including a first housing 120 having a generally elongated and planar shape. The first housing 120 has a first circular portion 122 at one end and a first extending portion 124 extending away from the first circular portion. For this closed position 110, the first circular portion 122 and the first extending portion 124 are adjacent to a second housing shown in FIG. 2.

FIG. 2, illustrates the radiotelephone 100 in an open position 210. Portions of the radiotelephone 100 that become visible when the first housing 120 is rotated to the opened position 210 include a second housing 220, and a user interface such as a keypad and a microphone aperture. When viewed from above, the second housing 220 of the radiotelephone has a substantially similar profile to the first housing 120. Similar to the first housing 120, the second housing 220 includes a second circular portion 222 and a second extending portion 224. For this opened position 210, the first circular portion 122 of the first housing 120 is planarly adjacent to, and positioned above, the second circular portion of the second housing 220. However, the first extending portion 124 is positioned away from the second housing. For example, as shown in FIG. 2, the first extending portion 124 is positioned opposite the second extending portion 124 on opposite sides of the first and second circular portions 122 & 222. The keypad may include any layout of keys that provide convenient operation of the radiotelephone 100 by the user.

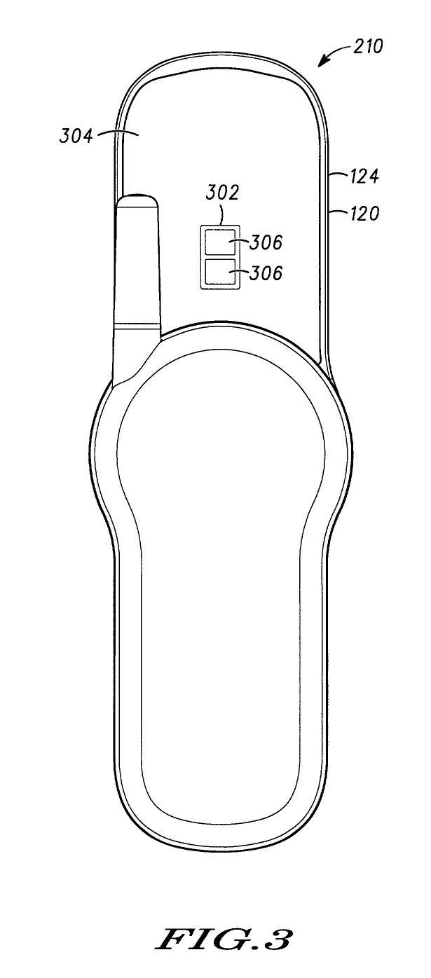

FIG. 3 shows the handheld wireless communication device with a user interface 302 on the inner surface 304 of the first housing 120. The user interface 302 in may be a set of two buttons and in the preferred embodiment comprise volume buttons 306. In the closed position 110, the buttons 306 are hidden or concealed between the first housing 120 and the second housing 220, as shown in FIG. 1. The volume buttons 306 as they are located are positioned such that the user can adjust the volume very easily with one finger, generally the index finger, of the hand holding the device.

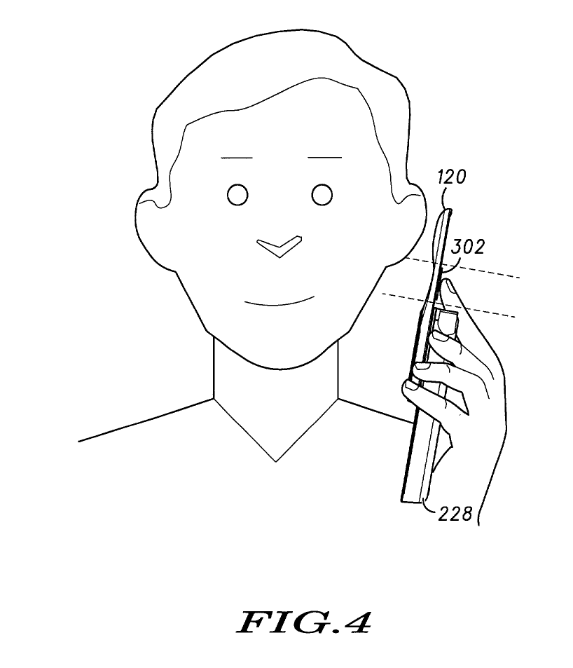

As illustrated in FIG. 4, when the device is in use, the user can easily position a finger on top of the inner surface 304 of the first housing 120. This is done to support the device and administer pressure to the housing such that a good seal is obtained between the speaker, which is in the first extending portion 124, and the users ear. In this position the volume buttons 306, located in or adjacent to the natural resting place of the user's index finger and are easily found by the user's finger and adjusted accordingly. The user does not have a to search for the volume buttons, or pull the device away from the users ear, temporarily interrupting the call, to find the buttons 306 and make the appropriate adjustments. Furthermore the, adjustments can be made while the device is up to the users ear and the adjust, monitor and repeat-adjust cycle is not necessary. The user adjusts during the call while positioned at the ear. Even though each user has a different index finger length, the resting position of the finger may be a given area on the inner surface 304 of the first housing portion 120. The user interface 302 is placed in the position that is adjusted for the average user and therefore accommodates most users.

Another function that may be activated by the user interface 302 includes changing between different modes of operation for a multimode device. For example, the buttons may be pushed determine whether the wireless communication device operates as a radiotelephone, a pager, a network browser, an e-mail device, a personal digital assistant, or an audio player.

Still another function that may be activated by the user interface 302 includes scrolling through a predetermined selection of data shown on the display 140. For example, the upper extending portion 124 may be rotated to conveniently move up and down a list of contacts and/or phone numbers, or a listing of alphanumeric characters (i.e. “A” through “Z”, “a” through “z”, “0” through “9”, and any special characters). This feature may also be used to operate functions that are not necessarily shown on the display 140, such as volume control.

While the invention has been described in detail above, the invention is not intended to be limited to the specific embodiments as described. It is evident that those skilled in the art may now make numerous uses, modifications of, and departures from the specific embodiments described herein without departing from the inventive concepts.

What is claimed is:

1. A handheld wireless communication device comprising:
a first housing portion having a first surface;
a second housing portion having a second surface, said second housing portion movably coupled to said first housing portion,
said second housing portion rotates planarly about a portion of and relative to said first housing portion from
a closed position wherein said first surface is adjacent to said second surface to
an open position wherein said first surface and said second surface are exposed; and
a user interface disposed upon said first surface,
said user interface exposed when said handheld wireless communication device is in said open position, and
concealed between said first housing portion and said second housing portion when said handheld wireless communication device is in said closed position.

2. The handheld wireless communication device of claim 1 wherein the user interface comprises a set of volume buttons.

3. The handheld wireless communication device of claim 1 wherein said first housing portion further comprising a first rotation portion and a first extended portion extending from said rotation portion, and wherein said second housing portion further comprises a second rotation portion and a second extended portion extending from said second rotation portion.

4. The handheld wireless communication device of claim 3 wherein said second extended portion extends at least over said user interface when said device is in said closed position.

5. The handheld wireless communication device of claim 1 wherein said first housing portion and said second housing portion are substantially the same size.

6. The handheld wireless communication device of claim 3 in said open position said first extended portion is angularly displaced 180 degrees from said second extended portion.

7. The handheld wireless communication device of claim 1 wherein the location of said user interface is located at the natural resting place of a users index finger.

8. The handheld wireless communication device of claim 1 wherein the location of said user interface is located near the natural resting place of a users index finger.

9. A handheld wireless communication device comprising:
a first housing portion having an inner surface and an outer surface;
a second housing portion having an inner surface and an outer surface, said second housing portion rotatably (also do movably) coupled within the same plane to said first housing portion, such that in a closed position, said inner surface of said first housing portion is planarly adjacent to said inner surface of said second housing portion, and
in an open position, the inner surface of said first housing portion is exposed and planarly opposed from said inner portion of said second housing portion; and
a user interface disposed upon said inner surface of said second housing portion, exposed and accessible to the user when said device is in said open position.

10. The handheld wireless communication device of claim 9 further comprising a user interface disposed upon the inner surface of said first housing portion

11. The handheld wireless communication device of claim 10 said user interface comprising buttons.

12. The wireless communication device of claim 11 said buttons comprising a volume increase button and a volume decrease button.

13. The wireless communication device of claim 9 wherein said user interface disposed upon the inner surface of said second housing portion has a location on said inner surface adjacent to the resting position of a users finger, while the device is in a open position.

14. A wireless communication device comprising:
a first housing;
a second housing movably coupled to the first housing, the second housing being capable of rotating about at least a portion of the first housing; and
A user interface disposed on said second housing wherein said user interface is accessible to the user when the second housing is in a first position, and not accessible to the user when the second housing is in a second position.

15. The wireless communication device of claim 14 wherein the user interface is a first volume button and a second volume button.

16. The wireless communication device of claim 15 wherein second housing in said first position is substantially planarly adjacent to said first housing, and wherein said second housing planarly rotates to said second position such that only a portion of said second housing is planarly adjacent to said first housing portion.

17. The wireless communication device of claim 15 wherein said user interface is on a first surface of said second housing and wherein said first surface is adjacent to said a first surface of said first housing when said wireless communication device is in said first position, and
Wherein the user interface is accessible to the user in said second position, and said user interface I located adjacent to the resting place of a user's index finger.

18. The wireless communication device of claim 14 wherein the first position is a closed position and the second position is an open position.

19. A wireless communication device comprising:
a first housing having a first circular portion and a first extending portion extending away from the circular portion;
a second housing having a second circular portion planarly aligned and planarly coupled to said first circular portion of said first housing and a second extending portion extending away from said second circular portion, the circular portion being capable of rotating about the center of the first circular portion, and wherein said second extending portion has a first surface; and
a user interface disposed upon said first surface of said second extending portion in a location adjacent to the resting position of a user's index finger.

20. The wireless communication device of claim 19 wherein said second housing portion comprises a second surface opposite said first surface.
